(19) United States
(12) Patent Application Publication
(10) Pub. No.: US 2025/0308245 A1
(43) Pub. Date: Oct. 2, 2025

(54) IMAGE SYNCHRONIZATION FOR ASYNCHRONOUS SYSTEMS AND METHODS

(71) Applicant: HITACHI, Ltd., Tokyo (JP)

(72) Inventors: Haruki MATONO, Novi, MI (US); Subrata Kumar KUNDU, Canton, MI (US)

(21) Appl. No.: 18/618,416

(22) Filed: Mar. 27, 2024

(51) Int. Cl. G06V 20/56; G01C 21/36; G06T 5/80; G06V 10/44; G06V 10/74

(52) U.S. Cl. CPC G06V 20/56; G01C 21/3635; G06T 5/80; G06V 10/44; G06V 10/761; G06V 2201/07

(57) ABSTRACT

Image synchronization systems and methods enable seamless integration of advanced triangulation and synchronization of different cameras that traditionally operate asynchronously. In various embodiments, this is accomplished by performing iterative steps for pairs of images that include comparing images obtained from two cameras, calculating a flatness score indicative of an error, and selecting a pair of images that is associated with the lowest error to identify synchronized images.

### BACKGROUND

### Field

The present disclosure is generally directed to autonomous driving, and more specifically, to systems and methods for autonomous docking of vehicles, such as freight trucks, at a docking facility, e.g., a warehouse.

### Related Art

Connected technology is increasingly becoming a core technology for the enhancement of vehicle safety and security. The push towards the standardization of collision avoidance technologies, such as automatic emergency braking, represents an important advancement in preventive safety measures. It is slated to become mandatory for commercial trucks in the United States by 2025. Amidst the global driver shortage that challenges the logistics industry, strategies to recruit younger and more female drivers are being implemented. Yet, as these initiatives unfold, the demand for efficient transportation continues to escalate.

For novice drivers, the task of parking large vehicles can be challenging, requiring a thorough understanding of the environment and the need for appropriate assistance tailored to ensure safe and efficient parking. The substantial size of these vehicles necessitates monitoring surrounding areas beyond what onboard cameras can capture.

While traditional external camera systems oversee areas like parking spaces and loading docks, their applications are usually limited to detecting suspicious activities, gathering evidence in case of accidents, etc., rather than facilitating assistance to drivers of incoming vehicles.

Therefore, it would be desirable to have systems and methods that integrate external cameras monitoring an entire parking area with those onboard the vehicle to provide operational support for large vehicles and facilitate the generation of safe routes. Such systems hinge on the synchronization of different cameras that traditionally operate asynchronously. Synchronization is vital for the accurate localization of moving objects across various camera views, thereby enhancing the safety and efficiency of vehicle operations.

### SUMMARY

Aspects of the present disclosure can involve an image synchronization method that for pairs of images, iteratively performs steps comprising: comparing each of a set of images obtained from a first camera with an image of a second camera; and calculating a flatness score that is indicative of an error; among the pairs of images, selecting the pair associated with the lowest error; and identifying the images associated with that pair as being synchronized.

In some aspects, an image synchronization system comprises a first camera configured to capture a set of images; a second camera configured to capture an image; and one or more processors configured to iteratively perform steps, for pairs of images, the steps including comparing each of the set of images obtained from the first camera with the image of the second camera; and calculating a flatness score that is indicative of an error; among the pairs of images, selecting the pair associated with the lowest error; and identifying the images associated with that pair as being synchronized.

In some aspects, the techniques described herein relate to a non-transitory computer-readable medium for storing instructions for executing a process, the instructions including: for pairs of images, iteratively performing steps including comparing each of a set of images obtained from a first camera with an image of a second camera; and calculating a flatness score that is indicative of an error; among the pairs of images, selecting the pair associated with the lowest error; and identifying the images associated with that pair as being synchronized.

The first camera is a vehicle-mounted camera (VC) and the second camera is an infrastructure camera (IC) that provide different perspectives of a same environment. The synchronized images may be utilized in a computer vision application including a vehicle navigation process.

In some aspects, a vehicle information system is coupled to a vehicle and performs steps comprising: receiving at least one image of the set of images; obtaining, from a server, global navigation satellite system (GNSS) information; using the GNSS information to determine a location of the vehicle; communicating the location to the server; receiving, from the server, a three-dimensional (3D) map that includes an area surrounding the vehicle; or using the GNSS information to perform a rectification operation to compensate a perspective distortion in the at least one image. The 3D map includes location information associated with one or more ICs, and the comparing steps may include using an infrastructure system to match a first point that has been extracted from the first camera to a second point that has been extracted from the second camera to obtain a pair of matched points.

In some aspects, the first or second point can be extracted by using an oriented features from accelerated segment test and rotated binary robust independent elementary features (ORB) process to identify a distinctive feature that is used to perform a localization operation. Further, a disparity between the pair of matched points can be used to calculate a distance that is associated with a 3D position for the pair of matched points and is treated as the flatness score.

In some aspects, the techniques described herein relate to a method, further including using a frame-by-frame comparison to monitor changes in flatness over time or across different parts of a surface. Outliers are removed from a set of matched points.

In some aspects, a spatial database can be used to detect, in the image of the second camera, a landmark position that is used to determine an initial position of the IC. Further, a disparity between pairs of matched areas of the environment that are expected to be flat to assess a flatness of an area is determined.

Aspects of the present disclosure can involve a system, which can involve means for capturing a set of images, means for capturing an image, and; means for iteratively performing steps, for pairs of images, the steps including: comparing each of the set of images with the image; calculating a flatness score that is indicative of an error; among the pairs of images, selecting the pair associated with the lowest error; and identifying the images associated with that pair as being synchronized.

### BRIEF DESCRIPTION OF DRAWINGS

FIG. 1 illustrates a simplified system for autonomous docking of freight trucks at a warehouse docking station, according to various embodiments of the present disclosure.

FIG. 2 depicts a capture timing chart that illustrates a common issue with traditional systems using asynchronous cameras.

FIG. 3A and FIG. 3B are exemplary flowcharts illustrating an image synchronization process for identifying synchronous frames captured by asynchronous cameras, according to various embodiments of the present disclosure.

FIG. 4 depicts a capture timing chart and matching frames, according to various embodiments of the present disclosure.

FIG. 5 is an exemplary graph illustrating a periodic consistency score, according to various embodiments of the present disclosure.

FIG. 6 is an exemplary flowchart illustrating a generalized image synchronization process, according to various embodiments of the present disclosure.

FIG. 7 illustrates an example computing environment with an example computer device suitable for use in various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In this document, the terms “frame” and “image” are used interchangeably. Similarly, the terms “flatness score” and “periodic consistency score,” and the terms “matching point” and “matched point” are used interchangeably.

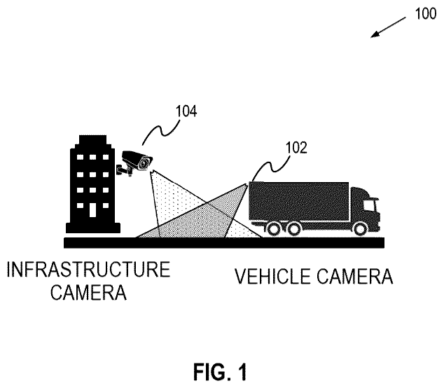

FIG. 1 illustrates a simplified system for autonomous docking of freight trucks at a warehouse docking station, according to various embodiments of the present disclosure. Some existing approaches require the measurement of trajectories from diverse cameras to optimize the positioning of the planar three degrees of freedom (DoF) trajectory. The trajectory is then further refined by subsequently processing it through continuous-time simultaneous localization and mapping (SLAM). Additionally, a shape-based point correspondence estimation method is applied for multi-sensor time calibration. However, measuring the trajectory of a moving object remains essential for synchronizing multiple sensors, a process that becomes particularly critical when a vehicle enters a parking lot. This process requires capturing the moving object, this necessitating the installation of specialized equipment. Further, the scalability of this system across numerous parking lots presents a significant challenge, as the introduction of new equipment to these facilities poses logistical and economic constraints. Accordingly, it would be desirable to have systems and methods that synchronize asynchronous imaging devices without the need for additional specialized equipment, thereby overcoming the limitations of existing systems.

Therefore, systems and methods herein optimize sensor data integration and employ advanced calibration techniques, such that the streamlined synchronization process offers a more practical and cost-effective solution for enhancing the safety and efficiency of parking large vehicles.

In various embodiments, this is accomplished by accumulating a sequence of images from a Vehicle Camera (VC), e.g., camera 102, and using the accumulated images and an image from an Infrastructure Camera (IC), e.g., camera 104 to perform stereo matching. This generates three-dimensional (3D) information sets for system 100, which can then be used to calculate a degree of match with pre-measured 3D map information associated with a parking lot. As discussed in greater detail below, this enables the determination of the closest in time images captured by cameras 102, 104, respectively, that operate in separate and distinct parts of system 100. Furthermore, in situations where it is not feasible to calculate a degree of match with the obtained 3D map information, e.g., due to the presence of obstructions, a method for estimating planes within the free space on the road may be employed that uses the 3D information sets to select an image pair that is most planar to perform synchronization.

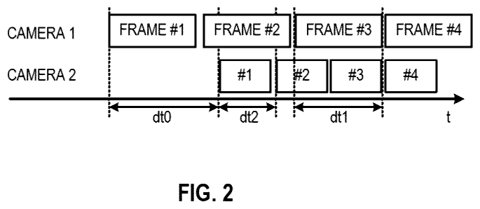

FIG. 2 depicts a capture timing chart that illustrates a common issue with traditional systems that employ asynchronous cameras. Camera 1 in FIG. 2 represents a VC, and camera 2 represents IC, similar to cameras 102 and 104 shown in FIG. 1. A main challenge in existing systems that use asynchronous cameras hinges on camera 1 and camera 2 operating in a manner such as to capture images independently within different systems or in different parts within the same system.

In detail, the horizontal axis in FIG. 2 represents a time ‘t’, and ‘dt0’ denotes a time delay between camera 1 and camera 2 that is caused mainly by camera-internal processing and transmission path latencies. The imaging period of camera 1 is denoted as ‘dt1’ and the imaging period of camera 2 is denoted as ‘dt2’. The numbering within each rectangle indicates the number of images captured by each respective camera, e.g., counting from the startup condition. As a person of skill in the art would understand, the presence of the time delay presents a challenge in that ‘dt0’ cannot be accurately determined in situations when there are no known moving objects within a common imaging range of both cameras, i.e., camera 1 and camera 2.

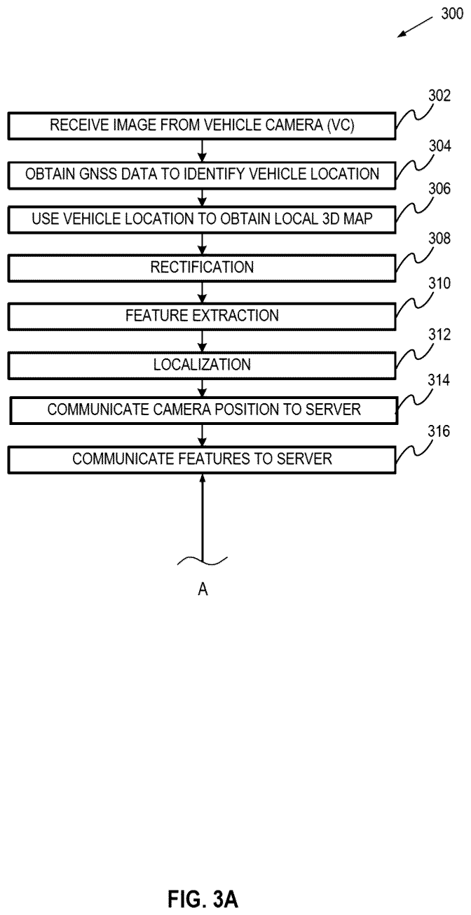

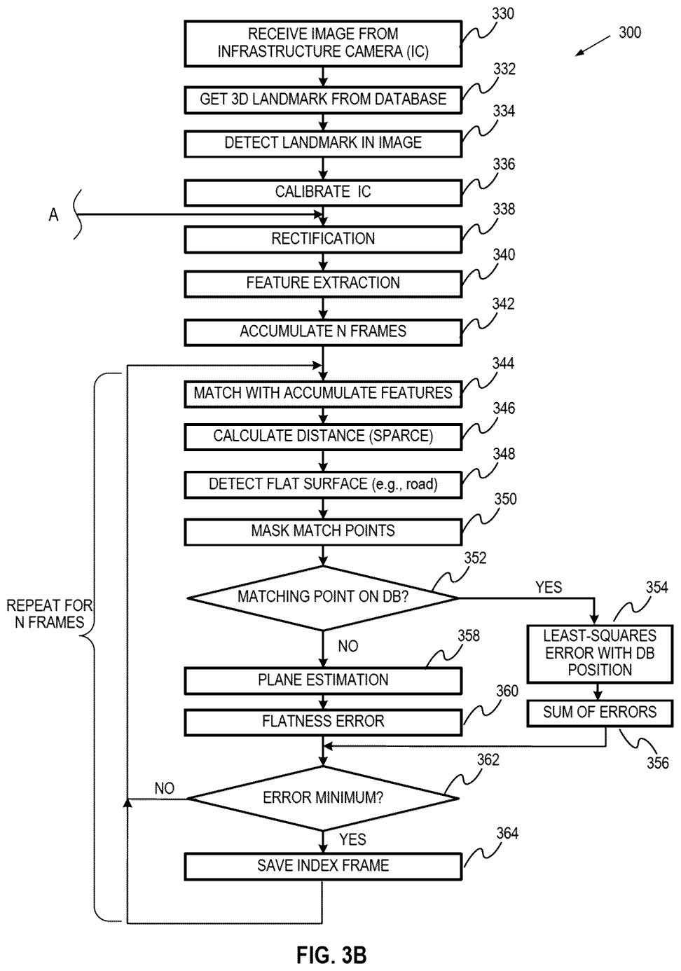

FIG. 3A and FIG. 3B are exemplary flowcharts illustrating an image synchronization process for identifying synchronous frames captured by asynchronous cameras, according to various embodiments of the present disclosure. Image synchronization process 300 may be used, for example, in scenarios where a vehicle equipped with cameras performs maneuvers in a parking lot that comprises built-in ICs. The section of flowchart 300 shown in FIG. 3A illustrates steps associated with a VC. It is noted that although the examples herein focus on a front VC, the teachings of the present disclosure may equally be applied to vehicles that are equipped with additional cameras, such as rear cameras.

In embodiments, process 300 starts at step 302, when a vehicle information system receives images from a VC. The images may be provided to the vehicle information system in a sequence of images that have been captured over time as the vehicle moves in a forward direction.

At step 304, the vehicle information system acquires global navigation satellite system (GNSS) information (e.g., from a remote server) to determine an initial geographical position of the vehicle as a starting point.

At step 306, the vehicle information system may send the location data (e.g., in the form of GPS coordinates that position the vehicle on a map) to a server to receive a 3D version of the map that is localized to an area surrounding the VC. As discussed in greater detail below, this 3D map may comprise location information associated with ICs. The vehicle information system may, thus, use the positions of the ICs and the VC to align the VC images. In this context, alignment refers to transforming the viewpoint of each camera image such that a single point in real space appears on the same horizontal line in both cameras. As a person of skill in the art will appreciate, by aligning the images in this way, it becomes easier to efficiently calculate disparities because corresponding points on a pair of camera images only need to be searched horizontally. Once the disparity is calculated, the distance and 3D position may be determined using, e.g., triangulation techniques.

At step 308, the known GPS coordinates of the vehicle may be used to perform rectification operations and other computer vision tasks, e.g., in preparation for a stereo matching process to compensate for perspective distortions in the VC's images such as to ensure that all images captured by a moving camera have a consistent orientation.

At step 310, the vehicle information system may utilize a feature extraction process to identify feature points related to distinctive details in a VC image and cross-reference those feature points to known features in the area provided by the 3D map, e.g., roads, buildings, unique patterns, etc. It is understood that any feature point extraction method known in the art may be used, such as an ORB method or an ORB-SLAM method, which may also be used to update the VC's position information, e.g., by comparing corresponding points with previously calculated feature points.

The results of the matching process are used, at step 312, to refine the vehicle's location in its environment and/or align the images with coordinates of the initial map.

At step 314, the VC's position, e.g., along with orientation information, may be communicated to the server for further processing. For example, the server may use the camera's pose to perform calibration operations to correct 3D information, and the like.

In addition, at step 316, the feature points are transmitted to an Infrastructure Camera System (ICS) that, as discussed next, may fuse VC and IC extracted features to enable frame synchronization and stereo matching according to embodiments disclosed herein.

The flowchart section shown in FIG. 3B illustrates a process for synchronizing IC camera images with the IC camera images, according to various embodiments of the present disclosure. Once image data is received from an IC, at step 330, this IC image data is compared, at step 332, with 3D data obtained from a spatial database, e.g., a landmark database that comprises positional information about fixed objects, such as fire hydrants, trash cans, and signs, whose location typically are not subject to change.

At step 334, the IC image data may be used to identify any number of landmarks, e.g., to determine initial positions of the ICs. The initial positions may be used to detect and correct for potential changes in IC positions that may occur over time.

At step 336, the identified landmarks, whose global positions are known may be used to perform steps such as camera calibrations, e.g., camera location and orientation by comparing the global position of a landmark to that in an IC image.

At step 338, once VC images have been received from VCs, rectification may be used to simplify the subsequent process of finding corresponding points in a VC image and an IC image that together form a stereo image pair. As a person of skill in the art will understand, the search for matching points across two images can be limited to a search along a single dimension, e.g., along a horizontal line that is aligned with the horizontal axis of the right and left image in each stereo pair.

At step 340, a feature extraction process aligns the corresponding points in the stereo image pair. Matching of extracted features may be accomplished by calculating Oriented Features from Accelerated Segment Test (FAST) and Rotated Binary Robust Independent Elementary Features (BRIEF) (ORB) features from IC images and saving several of them in a sequence. The saved ORB features from the ICs may then be matched with ORB features obtained from the VC to calculate 3D positions of the matched points. Because both sets of features are generated from aligned images, the calculation of 3D positions is based on the principles of triangulation.

Once, a number of images or frames from the IC have been accumulated, at step 342, iteratively for each stereo image pair, a feature (or point) that has been extracted from an IC frame may be used to match a corresponding feature extracted from the VC image. For each feature matching point in one image, a disparity (or difference) between a corresponding feature matching point in another image can be used to facilitate depth estimations. This may be accomplished, for example, by using triangulation techniques that utilize disparity and known geometry information between the cameras to calculate, at step 346, distances between cameras whose precise positions are known and points associated with a particular landmark.

At step 348, a flat surface detection process may be used to identify pixels in an area of an image that is assumed to be flat, such as part of a road.

At step 350, matching points that are not part of the road area (i.e., outliers) are masked and/or removed.

At step 352, it is determined whether a matching point is present in the spatial database. If so, then, at step 354, a least square error may be calculated, e.g., by using the position of a landmark in the database, and, at step 356, a sum of the accumulated errors may be determined.

For any number of saved features, if feature points are found at the positions of landmarks in the database, the distance of the 3D positions may be recorded as error values, and the pair with the least errors may be determined at step 362. It is noted that if the timestamps are mismatched, the 3D positions may be inaccurate. Conversely, if the timestamps are synchronized, this characteristic may be used as an indication that the 3D error is minimized. In this manner, the synchronized frame can be calculated based on the smallest 3D error.

Finally, at step 364, each index frame may be saved and the process may revert to step 344 and be repeated for the next one of the N number of frames.

Conversely, if at step 352, it is determined that a matching point is not present in the spatial database, e.g., because a location pre-stored in the landmark database is blocked by an obstacle such that it cannot be used, then, at step 358, a 3D plane estimation or fitting process may be employed to calculate a flatness error, at step 360, e.g. as a distance between each feature and an ideal plane.

Then, the process can resume with step 362 to determine whether the error is as minimal as before.

A suitable plane estimation or fitting process may comprise determining a drivable area or free space in each image, e.g., by utilizing semantic segmentation and machine learning methods to calculate the position of the free space. In this context, semantic segmentation involves determining whether each pixel is associated with a predefined flat surface such as a road. For those feature points whose class label matches the category road, a plane estimation or fitting process may be conducted to evaluate the levelness of a feature or pixel relative to a reference (e.g., ground). This levelness is stored, e.g., as a value associated with an error, and the stereo pair associated with the highest degree of planarity may be selected from all the pairs. In embodiments, such a selection process is based on the principle that a discrepancy in time synchronization is associated with a corresponding discrepancy in camera positioning. As an example, if images of two cameras are farther apart than expected, a positive offset may be added to a disparity value to compensate for the disparity error.

Equation 1 below presents a formula for converting disparity into distance, where B represents a baseline distance between the cameras, f represents the focal length of the camera, Z represents a distance or depth of a point in a scene from the camera, and d represents the disparity between the matching points. The equation indicates that for constant disparity error, as disparity increases, the disparity error increases proportionally, thus, leading to a larger distance error in inverse proportion. In other words, disparity error causes a level surface to be perceived as being a curved surface.

By utilizing this characteristic, various methods herein determine synchronization between frames from different camera viewpoints based on whether a surface area is level. Conversely, the appearance of a surface as being curved upwards or downwards indicates the absence of proper synchronization. Therefore, by measuring levelness, it can be determined whether images are synchronized. It is noted that this process does not require prior landmark information, i.e., it allows for the identification of synchronized frames without the need for landmark memory. Further, this reduces operational costs associated with changes in the layout of the parking area, as there is no need to update or maintain a landmark database for synchronization purposes.

Z=Bf/d Eq. (1)

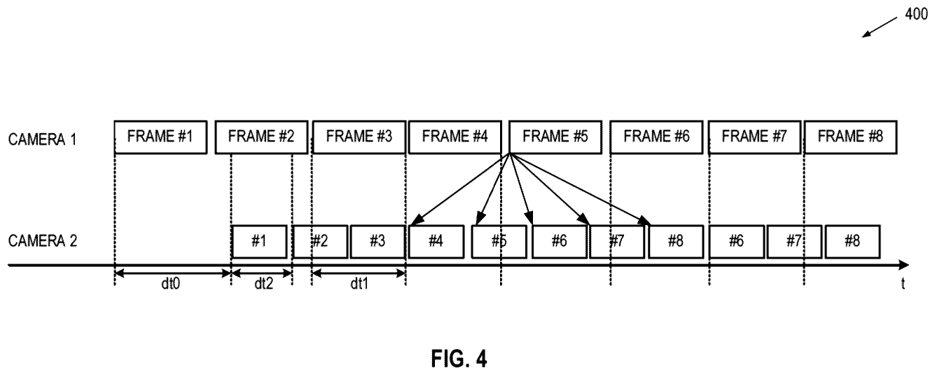

In embodiments, synchronization may involve two systems that operate on different cycles. Typically, the imaging frequency of a camera system is configured based on the specific needs of a given system. As an example, vehicle-mounted cameras (shown vehicle camera in FIG. 1) may require a faster imaging frequency, e.g., to detect sudden intrusions, pedestrian crossings, and the like. On the other hand, cameras within a parking lot (shown as infrastructure cameras in FIG. 1) used for monitoring vehicles or individuals do not need to capture images as frequently, since there is not much movement within the camera's view, making a slower imaging frequency sufficient. Moreover, in some applications, such as surveillance, reducing the imaging frequency is desirable to decrease the overall volume of data that needs to be transferred and stored. FIG. 4 illustrates such variations in imaging frequencies between two camera systems.

FIG. 4 depicts a timing diagram comprising matching frames, according to various embodiments of the present disclosure. Camera 1 in timing diagram 400 may represent images captured by the infrastructure camera in FIG. 1, and camera 2 may represent images captured by the vehicle-mounted camera. Timing diagram 400 illustrates the process of searching, among the frames captured by camera 2, the frame that is the closest in time relative to frame number 5 of camera 1. In the example in FIG. 4, that image is number 6, thus frame 5 and image number 6 may be viewed as the most synchronized images. Based on this technique, for each selected frame of camera 1, which serves as a reference frame, corresponding scores may be calculated that indicate a distance to that frame to determine which image of camera 2 is the closest to the selected frame.

In detail, each of camera 1 and camera 2 accumulates images numbered 1 through 8 that each may be used to iteratively perform a stereo matching process in the following manner. Each image of camera 2 creates a pair with frame 5 of camera 1, which may serve as a reference frame. For each pair, iteratively, a 3D image is created and used to calculate a flatness score, e.g., for a 3D image. The pair that has the flatness score that is associated with the most flatness is used to identify an image of camera 2, here image 6 of camera 2, to synchronize the image data.

As previously mentioned, when the imaging frequencies differ, there is no guarantee that captured images will be perfectly synchronized. The most synchronized images can be determined by utilizing known landmarks to calculate the error and levelness. The aggregate of such errors or levelness is referred to herein as periodic consistency score or flatness score. As a person of skill in the art will appreciate, users may select whether the measure of flatness should be represented by a low score or a high score.

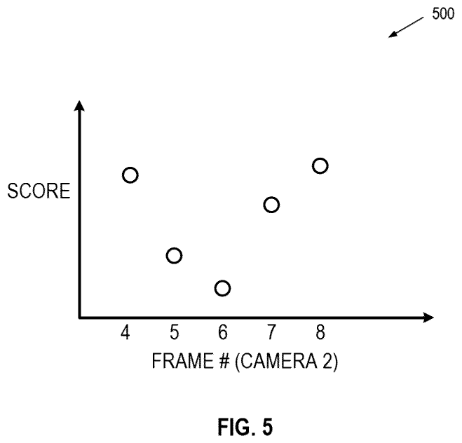

FIG. 5 is an exemplary graph illustrating periodic consistency scores, according to various embodiments of the present disclosure. The selected reference frame in FIG. 5 is frame #5 (shown in FIG. 4). As shown in graph 500, frame numbers 4 through 8, which have been captured by camera 2, are displayed along the X-axis. For each frame number, a corresponding score is displayed along the Y-axis. As depicted, frame number six has the lowest score value, here, indicating that frame number six has the highest degree of flatness among the frames captured by camera 2. Thus, frame number six corresponds to the timing diagram in FIG. 4, which confirms a match between frame number 5 of camera 1 and frame number 6 of camera 2.

In practice, when imaging frequencies of two cameras differ, for a given time series, scenarios where timings are close to each other or farther apart will repeat. When the capture timings of camera 1 and camera 2 are close, the periodic consistency score is low, and when the capture timings are far apart, the score is high. Captured image pairs that exhibit misaligned timings inherently include more distance error, thus reducing the reliability of the distance measurements. In embodiments, the reliability of image pairs may be monitored in this way. Since the periodic consistency score is calculated within an image synchronization process, it obviates the need for a new or different reliability score calculation, thereby reducing computational costs and expanding the range of potential applications for system that utilize this concept.

Further, memory demand for synchronization processing may also be reduced. Returning to FIG. 4, once a system is in place, the time delay, dt0, generally remains a constant and has a fixed value. Therefore, although a relatively large buffer may temporarily be used to accumulate image data at the start of a synchronization between camera 1 and camera 2, once a synchronized frame has been determined according to the description above, only images around the synchronized frame that are separated by the time delay are retained. Advantageously, this approach significantly reduces the amount of memory required on a regular basis, enabling more applications to run on a single device.

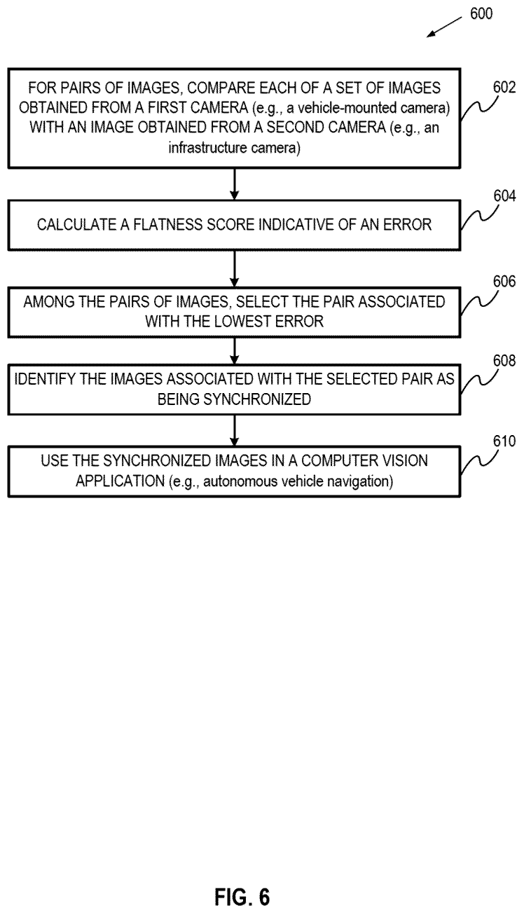

FIG. 6 is an exemplary flowchart illustrating a generalized image synchronization process, according to various embodiments of the present disclosure. Synchronization process 600 may start at step 602, when for pairs of images, each of a set of images received from a first camera is compared with an image of a second camera. At step 604, a flatness score indicative of an error is calculated. At step 606, among the pairs of images, the pair associated with the lowest error is selected. At step 608, the images associated with that pair are identified as being synchronized. Finally, at step 610, the synchronized images are used in a computer vision application, e.g., autonomous vehicle navigation.

Systems and methods herein not only simplify the synchronization of camera systems, they also facilitate the expansion of mobility solutions into the business sector. By eliminating the need for dedicated synchronization signals and reducing dependence on camera type or environmental conditions, businesses can more easily integrate the teaching of the present disclosure into existing infrastructure. This adaptability supports rapidly evolving mobility solutions, where the ability to deploy sophisticated systems with minimal setup complexity provides significant competitive advantages. The systems and methods herein enable seamless integration of advanced triangulation and camera synchronization that are crucial for applications in the smart transportation industry, such as autonomous driving support, traffic monitoring, and parking management systems.

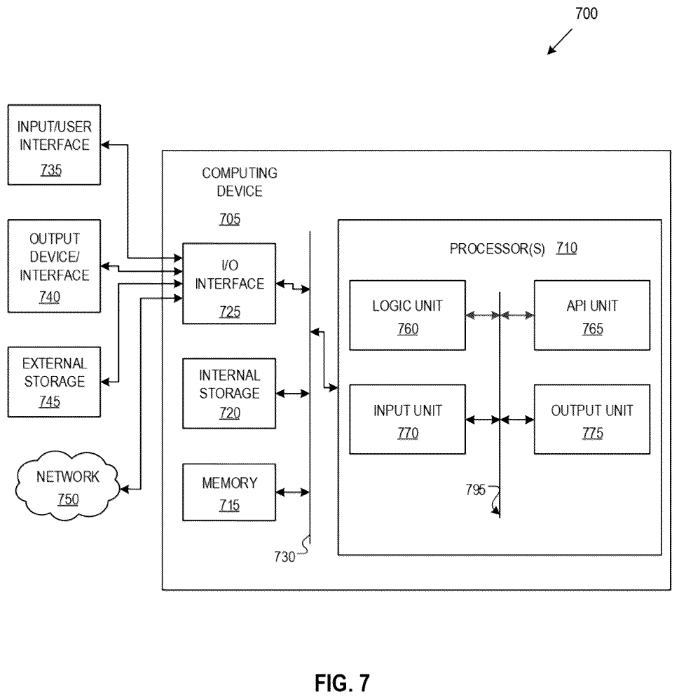

FIG. 7 illustrates an example computing environment with an example computer device suitable for use in various embodiments of the present disclosure, such as the autonomous docking system illustrated in FIG. 1 to serve as the platform to facilitate functionality for the docking system. Computer device 705 in computing environment 700 can include one or more processing units, cores, or processors 710, memory 715 (e.g., RAM, ROM, and/or the like), internal storage 720 (e.g., magnetic, optical, solid-state storage, and/or organic), and/or I/O interface 725, any of which can be coupled on a communication mechanism or bus 730 for communicating information or embedded in the computer device 705. I/O interface 725 is also configured to receive images from cameras or provide images to projectors or displays, depending on the desired implementation.

Computer device 705 can be communicatively coupled to input/user interface 735 and output device/interface 740. Either one or both of input/user interface 735 and output device/interface 740 can be a wired or wireless interface and can be detachable. Input/user interface 735 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 740 may include a display, television, monitor, printer, speaker, braille, or the like. In some example implementations, input/user interface 735 and output device/interface 740 can be embedded with or physically coupled to the computer device 705. In other example implementations, other computer devices may function as or provide the functions of input/user interface 735 and output device/interface 740 for a computer device 705.

Examples of computer device 705 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 705 can be communicatively coupled (e.g., via I/O interface 725) to external storage 745 and network 750 for communicating with any number of networked components, devices, and systems, including one or more computer devices of the same or different configuration. Computer device 705 or any connected computer device can be functioning as, providing services of, or referred to as a server, client, thin server, general machine, special-purpose machine, or another label.

I/O interface 725 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 700. Network 750 can be any network or combination of networks (e.g., the Internet, local area network, wide area network, a telephonic network, a cellular network, a satellite network, and the like).

Computer device 705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 710 can execute under any operating system (OS) (not shown), in a native or virtual environment. One or more applications can be deployed that include logic unit 760, application programming interface (API) unit 765, input unit 770, output unit 775, and inter-unit communication mechanism 795 for the different units to communicate with each other, with the OS, and with other applications (not shown). The described units and elements can be varied in design, function, configuration, or implementation and are not limited to the descriptions provided. Processor(s) 710 can be in the form of hardware processors such as central processing units (CPUs) or in a combination of hardware and software units.

In some example implementations, when information or an execution instruction is received by API unit 765, it may be communicated to one or more other units (e.g., logic unit 760, input unit 770, output unit 775). In some instances, logic unit 760 may be configured to control the information flow among the units and direct the services provided by API unit 765, input unit 770, output unit 775, in some example implementations described above. For example, the flow of one or more processes or implementations may be controlled by logic unit 760 alone or in conjunction with API unit 765. Input unit 770 may be configured to obtain input for the calculations described in the example implementations, and the output unit 775 may be configured to provide output based on the calculations described in example implementations.

Processor(s) 710 can be configured to execute a method or computer instructions which can involve, in response to receiving asynchronous images from a VC camera and a plurality of ICs, in the form of pairs of images, comparing each of a set of images received from the VC with an image of an IC, as shown, for example, in FIG. 3A and FIG. 3B. Processor(s) 710 can calculate a flatness score that is indicative of an error and select, among the pairs of images, the pair associated with the lowest error. Processor(s) 710 can then identify the images associated with that pair as being synchronized and use the synchronized images in a computer vision application, as shown in FIG. 6.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as, but not limited to optical disks, magnetic disks, read-only memories, random access memories, solid-state devices and drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. An image synchronization method comprising:
for pairs of images, iteratively performing steps comprising:
comparing each of a set of images obtained from a first camera with an image of a second camera; and
calculating a flatness score that is indicative of an error;
among the pairs of images, selecting the pair associated with the lowest error; and
identifying the images associated with that pair as being synchronized.

2. The method according to claim 1, further comprising utilizing synchronized images in a computer vision application comprising a vehicle navigation process.

3. The method according to claim 1, wherein the first camera is a vehicle-mounted camera (VC) and the second camera is an infrastructure camera (IC), the first and second cameras configured to provide different perspectives of a same environment.

4. The method according to claim 1, further comprising, at a vehicle information system communicatively coupled to a vehicle performing steps comprising at least one of:
receiving at least one image of the set of images;
obtaining, from a server, global navigation satellite system (GNSS) information;
using the GNSS information to determine a location of the vehicle;
communicating the location to the server;
receiving, from the server, a three-dimensional (3D) map that comprises an area surrounding the vehicle; or
using the GNSS information to perform a rectification operation to compensate a perspective distortion in the at least one image.

5. The method according to claim 3, wherein the 3D map comprises location information associated with one or more ICs.

6. The method according to claim 5, wherein comparing comprises using an infrastructure system to match a first point that has been extracted from the first camera to a second point that has been extracted from the second camera to obtain a pair of matched points.

7. The method according to claim 6, wherein at least one of the first point or the second point has been extracted by using an oriented features from accelerated segment test and rotated binary robust independent elementary features (ORB) process to identify a distinctive feature that is used to perform a localization operation.

8. The method according to claim 6, further comprising using a disparity between the pair of matched points to calculate a distance associated with a 3D position for the pair of matched points, and treating the distance as the flatness score.

9. The method according to claim 7, further comprising using a frame-by-frame comparison to monitor changes in flatness over time or across different parts of a surface.

10. The method according to claim 7, further comprising identifying and removing outliers from a set of matched points.

11. The method according to claim 1, further comprising using a spatial database to detect a landmark position in the image of the second camera.

12. The method according to claim 11, further comprising using the landmark position to determine an initial position of the IC.

13. The method according to claim 3, further comprising determining a disparity between pairs of matched areas of the environment that are expected to be flat to assess a flatness of an area.

14. An image synchronization system comprising:
a first camera configured to capture a set of images;
a second camera configured to capture an image;
one or more processors configured to iteratively perform steps, for pairs of images, the steps comprising:
comparing each of the set of images obtained from the first camera with the image of the second camera; and
calculating a flatness score that is indicative of an error;
among the pairs of images, selecting the pair associated with the lowest error; and
identifying the images associated with that pair as being synchronized.

15. The system according to claim 14, wherein the first camera is a vehicle-mounted camera (VC) and the second camera is an infrastructure camera (IC), the first and second cameras configured to provide different perspectives of a same environment.

16. The system according to claim 14, further comprising a computer vision application configured to use the synchronized images in a vehicle navigation process.

17. The system according to claim 14, further comprising a vehicle information system communicatively coupled to a vehicle, the vehicle information system performing steps comprising at least one of:
receiving at least one image of the set of images;
obtaining, from a server, global navigation satellite system (GNSS) information;
using the GNSS information to determine a location of the vehicle;
communicating the location to the server;
receiving, from the server, a three-dimensional (3D) map that comprises an area surrounding the vehicle; or
using the GNSS information to perform a rectification operation to compensate a perspective distortion in the at least one image.

18. The system according to claim 14, wherein the one or more processors are configured to determine a disparity between pairs of matched areas of the environment that are expected to be flat to assess a flatness of an area.

19. The system according to claim 14, further comprising a spatial database that comprises a landmark.

20. A non-transitory computer-readable medium for storing instructions for executing a process, the instructions comprising:
for pairs of images, iteratively performing steps comprising:
comparing each of a set of images obtained from a first camera with an image of a second camera; and
calculating a flatness score that is indicative of an error;
among the pairs of images, selecting the pair associated with the lowest error; and
identifying the images associated with that pair as being synchronized.
